(19) United States
(12) Patent Application Publication
(10) Pub. No.: US 2011/0061158 A1
(43) Pub. Date: Mar. 17, 2011

(54) TRACK ASSEMBLY WITH APPARATUS FOR FORMING DECK EDGING FOR SWIMMING POOLS

(75) Inventor: Lanny R. Smith, Alpine, UT (US)

(73) Assignee: COVERSTAR, LLC, Lindon, UT (US)

(21) Appl. No.: 12/952,985

(22) Filed: Nov. 23, 2010

Related U.S. Application Data
(63) Continuation of application No. 10/290,548, filed on Nov. 8, 2002, now Pat. No. 7,861,471.
(60) Provisional application No. 60/347,260, filed on Nov. 8, 2001.

(51) Int. Cl. E04H 4/00; B23P 11/00

(52) U.S. Cl. 4/506; 29/428

(57) ABSTRACT

An apparatus is provided for constructing edging around the perimeter of a swimming pool having a decking and a retractable pool cover, wherein an elongated guide connector is attached to a wall of the swimming pool for connecting to a guide member for the pool cover, that includes a form member shaped to form the edging, and a form mating structure on the form member for removably mating the form member to the elongated guide connector.

### RELATED APPLICATION

This application is a Continuation application of U.S. patent application Ser. No. 10/290,548, filed Nov. 8, 2002 titled “Track Assembly With Apparatus for Forming Deck Edging for Swimming Pools,” which application claim the priority under 35 U.S.C. §119(e) of U.S. Provisional Patent Application No. 60/347,260, filed Nov. 8, 2001 titled “Encapsulated Track Assembly for Swimming Pools,” the contents of which are incorporated herein by reference in their entireties.

### BACKGROUND

1. Field of Invention

The present disclosure relates to swimming pools, and, more particularly, to a track assembly with apparatus for forming deck edging for swimming pools.

2. Background

Swimming pools are commonly covered to prevent debris from entering the pool, to preserve chemical treatments in the water and to heat the pool in the case of a solar cover. An automatic pool cover provides convenience for a user by allowing the cover to be easily extended over the pool during periods of non-use, and retracted during periods of use. Typically, automatic pool covers utilize a track assembly built into the walls for guiding the leading edge bar of the cover as it traverses the pool. Such track assemblies are difficult to install and add clutter to the pool sides that may be unsightly and awkward to use.

In forming the coping and edging around the perimeter of pools it is useful to employ a mechanism in or attached to the pool walls that will provide uniformity in the coping and that can be easily installed and removed. Current forms are typically made of disposable materials, such as styrofoam, wood forms or other such materials. Such forms were often attached to the pool by two-sided tape or other temporary means. Often they were damaged during removal, so that new forms had to be used for each installation.

For pools with automatic vinyl covers, it is useful to have a mechanism in the pool walls that secures the bead of the vinyl liner to prevent wear and to maintain suitable appearance and structure. It is desirable that such a mechanism is simple, easy to install and firmly secures the edge or bead of the vinyl liner to the pool walls.

In addition, it is sometimes desirable to secure fiber optic lights or other decorative items in or around the pool walls. Using separate securing mechanisms for these purposes adds to the expense and installation time involved with pool construction.

Accordingly, a multiple purpose assembly for pool walls is needed that can perform one or more of the foregoing functions while minimizing the time and expense of installation. Such an assembly should be relatively simple and unobtrusive and should be flexible to accommodate various needs of different types of pool construction. Preferably, the assembly may include coping and edging forms that are easy to affix, provide uniformity in the forming function and are reusable to minimize cost.

### SUMMARY

The present disclosure provides a multiple purpose encapsulation member that is able to carry out the functions described above. The encapsulation member includes an element for guiding a pool cover edge as it is retracted and extended. The member may further include an element for securing a form piece to be used in forming the edge of the pool decking. The form may be removably secured to the member, enabling it to be reused and for different forms to be utilized with a common encapsulation member. In addition, the member may provide an element for securing a bead on the end of a vinyl liner. Further the member has an element for securing fiber optic light tubing or other decorative elements.

In one implementation apparatus is provided for constructing edging around the perimeter of a swimming pool having a decking and a retractable pool cover wherein an elongated guide connector is attached to a wall of the swimming pool for mating to a guide member for the pool cover. The apparatus comprises a form member shaped to form the edging, and a form mating structure on the form member for removably mating the form member to the elongated guide connector. For purposes of this application, the term “mating” shall mean in contact, in an adjoining relationship, fit together, joined, or connected.

In another implementation, apparatus is provided for attaching to a wall of a swimming pool having a decking and a retractable pool cover, and disposed to accommodate a guide member for the edge of the pool cover as the cover extends and retracts. The apparatus comprises an elongated track member attached to the wall of the swimming pool to accommodate the guide member, and a form element for forming an edge of the decking for the pool, the form element being removably mated to the track member.

In another implementation, a method is provided for constructing edging around the perimeter of a swimming pool having a decking and a retractable pool cover, comprising connecting an elongated guide connector to a wall of the swimming pool, and removably mating to the elongated guide connector a form member shaped to form the edging.

### BRIEF DESCRIPTION OF THE DRAWINGS

The above-mentioned and other features and advantages of this disclosure, and the manner of attaining them, will become more apparent and the disclosure will be better understood by reference to the following description of an implementation of the disclosure taken in conjunction with the accompanying drawings, wherein:

FIG. 1 is a plan view of a pool showing the location of the encapsulation assembly in the pool walls, according to the present disclosure;

FIG. 2 is a perspective view of an implementation of a encapsulation extrusion, according to the present disclosure;

FIG. 3 is a perspective view of another implementation an encapsulation extrusion, according to the present disclosure;

FIG. 4A is a perspective view of an implementation showing a cover guide extrusion according to the present disclosure;

FIG. 4B is a perspective view of an implementation showing a guide support spacer extrusion according to the present disclosure;

FIG. 5 is a perspective view of an implementation of a clip-on coping extrusion, according to the present disclosure;

FIG. 6 is a perspective view of one implementation of the encapsulation assembly, according to the present disclosure;

FIG. 7 is a perspective view of the implementation of FIG. 6 showing a vinyl liner and a pool cover, according to the present disclosure;

FIG. 8 is a perspective view of the implementation of FIG. 6 showing a portion of a deck and a guide cover, according to the present disclosure;

FIG. 9 is a perspective view of an implementation of a concrete form extrusion, according to the present disclosure;

FIG. 10 is a side view of the implementation of FIG. 9, in mating position with the encapsulation extrusion of FIG. 3, according to the present disclosure;

FIG. 11 is a perspective view of the implementation of FIG. 10 showing the deck and other members, according to the present disclosure;

FIG. 12 is a perspective view of the implementation of FIG. 9, alternately mated with the encapsulation extrusion of FIG. 2, according to the present disclosure;

FIG. 13 is a side view of the implementation of FIG. 3 showing the encapsulation extrusion disposed in a pool wall with masonry, according to the present disclosure;

FIG. 14 is a perspective view of another implementation showing an encapsulation extrusion for concrete pool walls, according to the present disclosure; and

FIG. 15 is a perspective view showing a cover for the encapsulation extrusion implementation shown in FIG. 14; and

FIG. 16 is a side view of the implementation of FIG. 14 showing the encapsulation extrusion disposed in a pool wall with masonry, according to the present disclosure.

Corresponding reference characters indicate corresponding parts throughout the several views. The exemplification set out herein illustrates one implementation of the disclosure, in one form, and such exemplification is not to be construed as limiting the scope of the disclosure in any manner.

### DETAILED DESCRIPTION

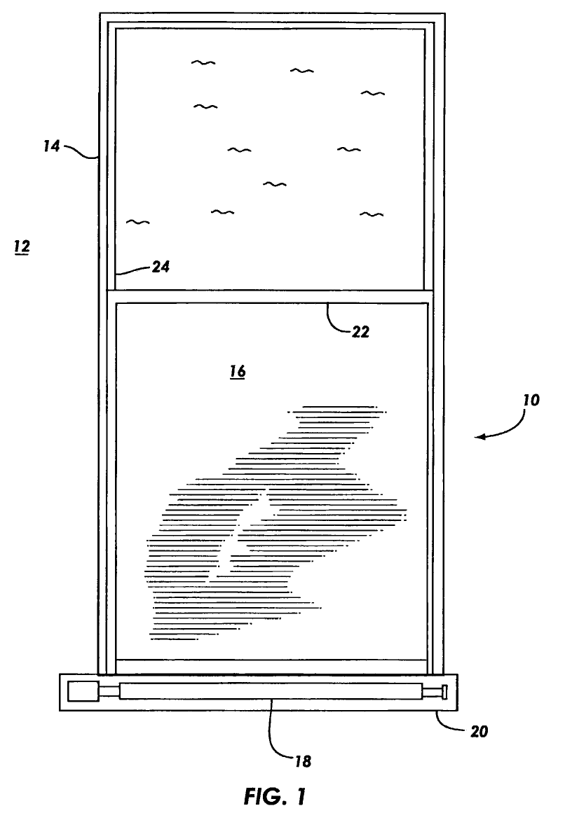

Referring now to the drawings, and more particularly to FIG. 1, an implementation of a rectangular swimming pool 10 is shown having a pool deck 12 and walls 14 surrounding the pool. An automatic pool cover 16 extends from a pool cover mechanism 18 in a cover assembly box 20 disposed at one end of the pool 10. A leading edge bar 22 at the front edge of the pool cover 16 rides in a track encapsulation assembly 24 along the interior walls of the pool.

Deck 12 is generally horizontal and is preferably constructed from concrete. Coping 14 connects to deck 12 in a substantially coplanar fashion along the edge of deck 12 facing the interior of swimming pool 10. Encapsulation track assembly 24 may include structure to retain vinyl lining, coping forms and structure for fiber optic lighting running along the length of the pool.

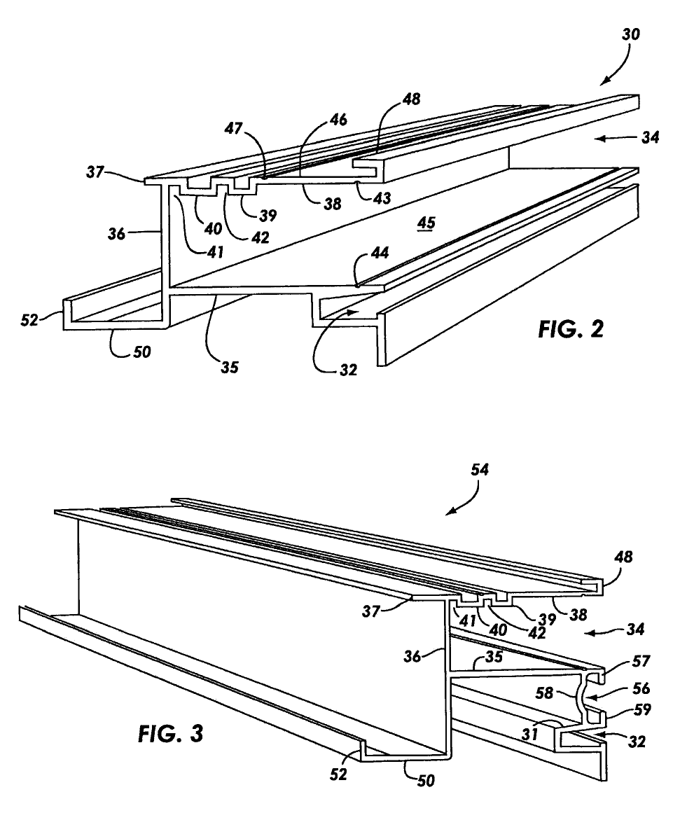

FIG. 2 shows an implementation of an encapsulation extrusion 30 according to the present disclosure. Extrusion 30 has an elongated slot 32 running along the bottom thereof to provide a cavity for securing the vinyl liner bead (not shown). A three-sided rectangular elongated cavity 34 formed by a bottom wall 35, a side wall 36 and a top wall 37, runs the length of extrusion 30 for receiving a cover guide extrusion, discussed below.

A bottom side 38 of top wall 37 includes protruding channels 39 and 40 that form grooves 41 and 42 for guiding the cover guide extrusion. Opposing elongated notches 43 and 44 are disposed in the bottom side 38 of top wall 37 and the top side 45 of bottom wall 35, respectively for securing a track cover, described below.

The top side 46 of top wall 37 includes an elongated lip 48 for securing a coping extrusion. Extending from the bottom of side wall 36 is an elongated L-shaped securing flange 50 running the length of the encapsulation extrusion. An elongated lip 52 extends from the end of flange 50 at approximately a right angle thereto. A small elongated groove (not shown) may be included to extend longitudinally along top side 46.

Referring now to FIG. 3, an alternate implementation is shown of an encapsulation extrusion 54 that is essentially identical to the implementation shown in FIG. 2, except for the addition of an elongated cavity 56 for securing fiber optic lighting. Cavity 56 is formed by a side wall 58 extending vertically between the bottom wall 35 and a top wall 31 forming elongated slot 32. Wall 58 may be shaped as desired to accommodate the fiber optic tubing. Retaining lips 57 and 59 extend towards each other in the front of cavity 56 to retain the tubing.

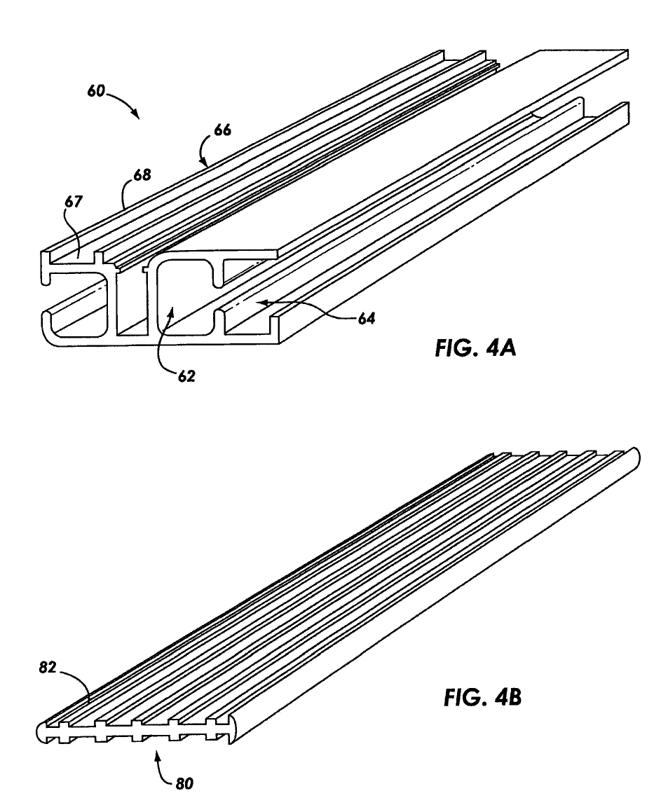

FIG. 4A shows an implementation of a cover guide extrusion 60, sized and shaped to fit inside the cavity 34 of the encapsulation extrusions 30 illustrated in FIG. 2 or 54 illustrated in FIG. 3. An elongated cavity 62 is formed in the cover guide extrusion 60 having an open side 64 for receiving the edge of a pool cover (not shown). The top wall 66 of cover guide extrusion 60 is shaped with elongated channels 67 and protrusions 68 that are adapted to engage the grooves 41 and 42 and the protruding channels 39 and 40 respectively (depicted in FIGS. 2 and 3) so that the cover guide extrusion is mated in cavity 34 with the encapsulation extrusions 30 or 54.

FIG. 4B discloses a guide support spacer extrusion 80 for wedging into the cavity 34 of the encapsulation extrusion 30 above or below the cover guide extrusion 60, to secure extrusion 60 tightly in the cavity 34. Spacer extrusion 80 may include elongated protrusions 82 to provide additional security.

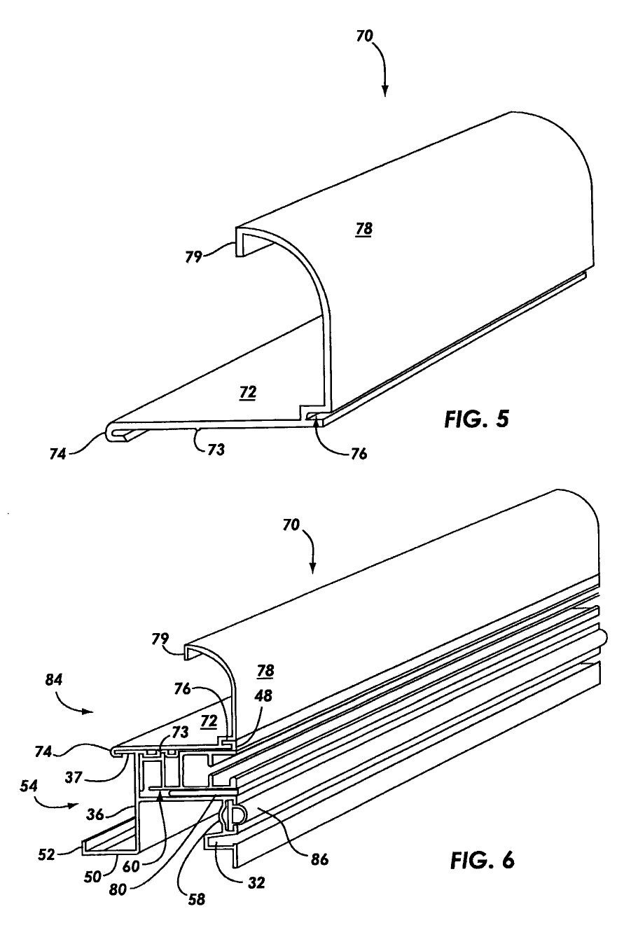

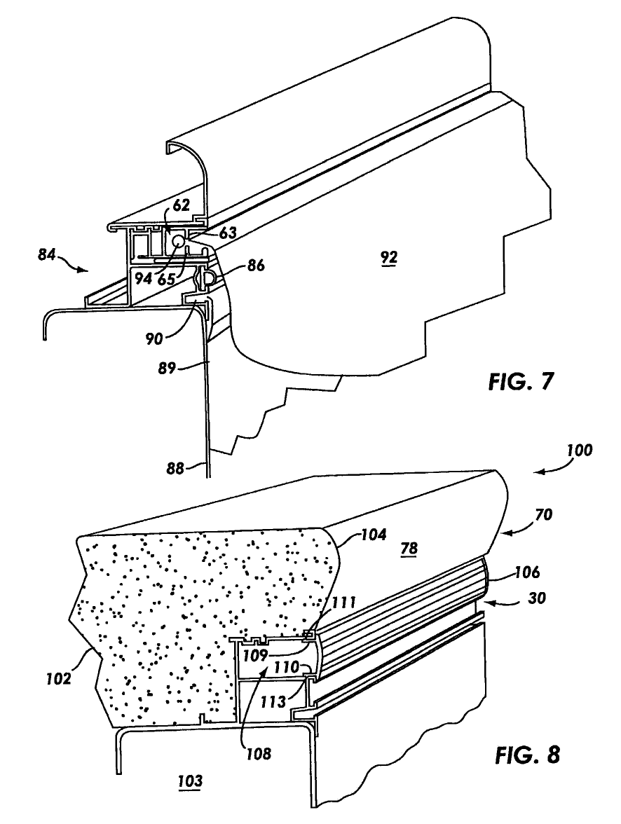

FIG. 5 discloses an elongated clip-on coping extrusion 70 for mating to the top wall 37 of the encapsulation extrusion 30. Extrusion 70 includes a flat member 72 having a lip 74 at one end and a slot 76 at the other end. A curved elongated member 78 is shaped to form the pool coping (not shown). Member 78 may be formed in any shape to provide the appearance desired for the coping. A lip 79 extends downward to secure the coping extrusion 70 to the top of encapsulation extrusions 30 or 54, shown in FIGS. 2 and 3. A snap hook extrusion 73 extends longitudinally along the undersurface of member 72 for further securing the coping extrusion 70, as disclosed below. Looking now at FIG. 6, the elements separately shown in FIGS. 3-5 are shown functional connection with each other to form an encapsulation assembly 84. Coping extrusion 70 is mated to encapsulation extrusion 54 by sliding lip 48 into slot 76 and by sliding lip 74 onto the end of top wall 37, as shown. Coping extrusion 70 is further secured by mating snap hook extrusion 73 into groove 47. Cover guide extrusion 60 is wedged in cavity 34 of encapsulation extrusion 54 by spacer extrusion 80. A fiber optic tube 86 is secured in cavity 56.

FIG. 7 shows the same assembly 84 including a vinyl liner 89 in contact with a side wall 88 and having a beaded edge 90 secured within cavity 62 of the encapsulation extrusion 30. A pool cover 92 is secured to assembly 84 by an elongated tubing 94 connected to the edge of cover 92 and secured in cavity 62. Preferably tubing 94 is smaller than the dimensions of the cavity 62 so that it can move freely along the cavity 62 as the pool cover is extended or retracted. Lips 63 and 65 at the front of cavity 62 retain tubing 94 in cavity 62. Support spacer extrusion 80 is pushed into the cavity 34 below the cover guide extrusion 60.

FIG. 8 shows another implementation of an encapsulation assembly 100 in which the encapsulated extrusion 30 of FIG. 2 is mated with the coping extrusion 70 of FIG. 5. Assembly 100 is embedded in an edge of a pool deck 102. Curved coping member 78 shapes the edge of the pool deck 104 to the configuration of member 78.

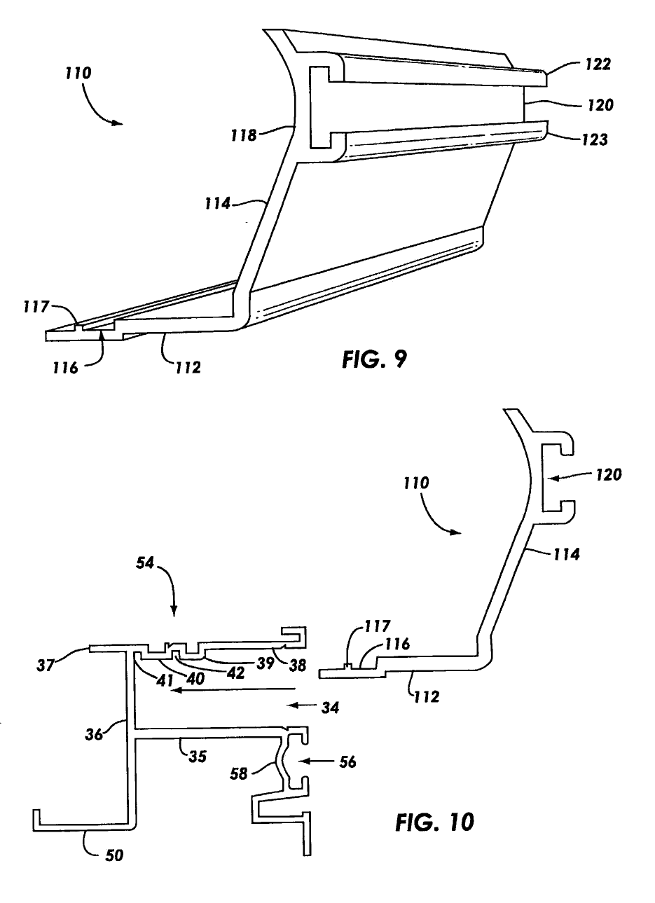

In this implementation, a cover guide is not used, either because a pool cover is not deployed or because the encapsulation assembly is disposed on a back wall of the pool where a pool cover guide extrusion is not needed. In such instances, cavity 108 may be capped by a cover 106 for cosmetic and safety purposes. Cover 106 is secured by small flanges 109 and 110 that extend into cavity 108. Tiny lips 11 land 113 at the end of flanges 109 and 110 mate with corresponding grooves, such as grooves 43 and 44 as shown in FIG. 2. Looking now at FIG. 9, a concrete form 110 is shown that can be attached to the encapsulation extrusions 30 or 54, shown in FIGS. 2 and 3. Form 110 is a generally L-shaped member having a bottom wall 112 and a side wall 114. Bottom wall 112 includes channel 116 and protrusion 117 that are formed to mate with corresponding protrusion 39 and channel 42 in the bottom side 38 of top wall 37, as shown in FIG. 3. Side wall 114 has a curvature 118 designed to shape the edge of the concrete decking of the pool. A channel 120 is formed along the back side of wall 114 for holding an alignment piece for aligning form 116 with adjacent form members. Opposing lip members 122 and 123 are formed to retain the alignment piece.

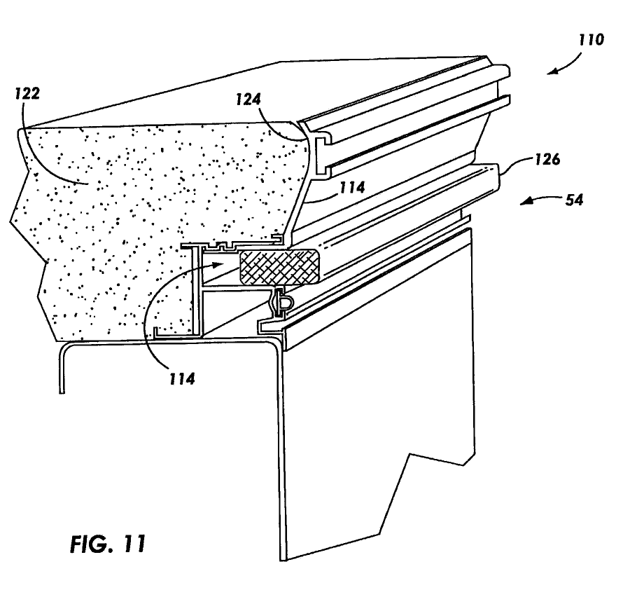

FIG. 10 shows the manner in which the concrete form 110 mates to the encapsulation extrusion 54. Bottom wall 112 extends into the cavity 34 of extrusion 54 so that channel 116 and protrusion 117 mate with the corresponding protrusion 39 and channel 42 of the bottom part 38 of top wall 37 of extrusion 54.

FIG. 11 shows the concrete form 110 and encapsulation extrusion 54 completely mated. A concrete deck 122 is formed adjacent thereto, with the shape of side wall 114 of form 110 determining the curvature of the deck edging 124. A spacer 126 is inserted into cavity 34 of encapsulation extrusion 54 to maintain the shape of the cavity during formation of the deck. Spacer 126 may be of any shape and material sufficient to maintain concrete form 110 snugly abutting the lower surface of encapsulation extrusion 54. After the deck is formed, concrete form 110 is removed from cavity 34, together with filler piece 126 so that the pool cover guide extrusion 60 can be inserted, as shown in FIG. 6.

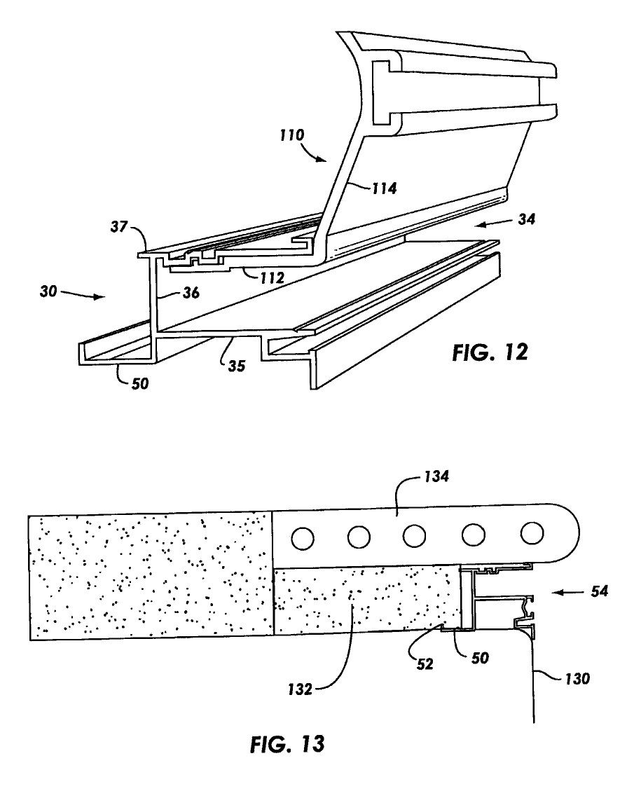

FIG. 12 show concrete form 110 mated with the encapsulation extrusion 30 shown in FIG. 2. FIGS. 11 and 12 together make it apparent that concrete form 110 will readily mate with both of the encapsulation extrusions 30 and 54 shown in FIGS. 2 and 3.

FIG. 13 shows the encapsulation extrusion 54 of FIG. 3 inset on the top of a pool wall 130. Flange 50 and lip 52 extend into the mortar 132 above the wall 130 to secure the extrusion 54. In this arrangement, masonry 134 is formed above extrusion 54 made of any appropriate material, such as brick, in any desirable shape to form an edge to the pool. In this situation, concrete form 110 or coping form 70 would not be required.

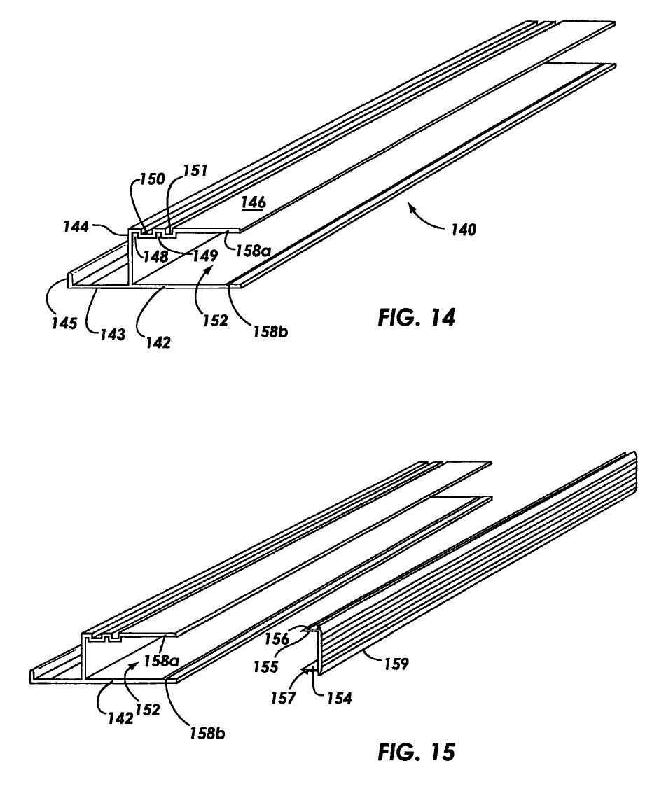

FIG. 14 shows an encapsulation extrusion 140 for use with gunite concrete pools rather than vinyl lined pools. In this implementation of the encapsulation extrusion no vinyl bead retention slot 32 or fiber optic cavity 56 are needed, as shown in the implementation of FIG. 3. Extrusion 140 has a bottom wall 142, a side wall 144 and a top wall 146 which form a cavity 152, similar to the shape of the other encapsulation extrusions shown in FIGS. 2 and 3. Also, a flange 143 with lip 145 extends from the intersection of bottom wall 142 and side wall 144, for securing the encapsulation extrusion 140 in an appropriate medium, such as mortar.

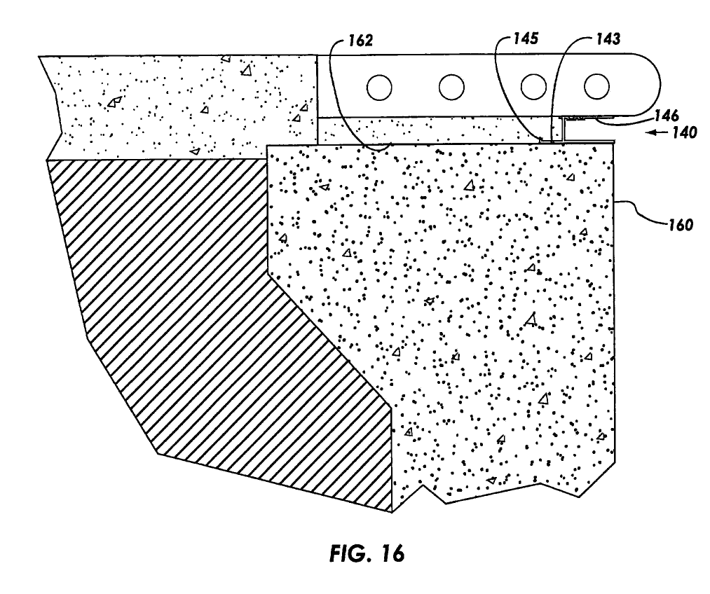

FIG. 14 includes channels 148, 149 and protrusions 150, 151 to mate with the cover guide extrusion 60 shown in FIG. 4A. When the cover guide extrusion 60 is not used, such as in the absence of a pool cover or along the wall of the pool opposite the pool cover assembly, an encapsulation gap cover 159 can be applied to cover cavity 152, as shown in FIG. 15. This arrangement is similar to the members shown in FIG. 8. Cover 159 includes flanges 154 and 155 each having tiny lips 156 and 157 that are designed to snap into elongated grooves 158a,b.

FIG. 16 discloses the encapsulation extrusion 140 shown in FIG. 14 inset on the top of a pool wall 160, similar to the implementation shown in FIG. 13. Flange 143 and lip 145 extend into mortar 162 to secure the extrusion 140. Masonry 164 of any appropriate design and shape rest on top of the top wall 146 of extrusion 140.

As can be seen, the encapsulated track assembly of the present disclosure can take several different shapes, depending on the type of pool and the functions required, including securing the vinyl liner, holding fiber optic lighting, positioning form extrusions to form deck coping or edging and guiding pool cover edge members as the cover is retracted and extended. This This multiple purpose system is simple, easy to construct and install and relatively inexpensive.

The encapsulated track assembly provides a simple means to insert a form for the decking into the assembly and then remove it for future use after the decking is formed. The concrete forms are reusable and are readily mated with the encapsulation assembly. Numerous additional advantages are apparent from the disclosure provided herein.

Although the above implementations are representative of the present disclosure, other implementations will be apparent to those skilled in the art from a consideration of this specification and the appended claims, or from a practice of the implementations of the disclosed disclosure. It is intended that the specification and implementations therein be considered as exemplary only, with the present disclosure being defined by the claims and their equivalents.

What is claimed is:

1. A method for constructing edging around the perimeter of a swimming pool having a decking and a retractable pool cover, comprising:
connecting an elongated guide connector to a wall of the swimming pool; and
removably mating to the elongated guide connector a form member shaped to form the edging.

2. The method of claim 1, wherein the form member is mated to the elongated guide connector so as to be removed after the edging is formed.

3. The method of claim 1, wherein the form member is mated to the elongated guide connector so as to be permanently affixed thereto after the edging is formed.

4. The method of claim 1, wherein the form member has a first mating element thereon and the elongated guide connector has a second mating element thereon, comprising the step of mating together the first and second mating elements.

5. The method of claim 1, further comprising the step of mating the form member to the elongated guide connector.

6. The method of claim 1, further comprising the step of securing the form member to the elongated guide while the edging is being formed with a removably securing element.

7. The method of claim 6 and further comprising providing malleable unformed edging material on the swimming pool wall to abut the form member.

8. The method of claim 7, further comprising allowing the edging material to harden against the form member.

9. The method of claim 8, further comprising removing the form member from the tracking member for reuse.

10. An apparatus for attaching to a wall of a swimming pool having a decking and a retractable pool cover, and disposed to accommodate a guide member for the edge of the pool cover as the cover extends and retracts, comprising:
an elongated track member attached to the wall of the swimming pool to form an elongated cavity for accommodating the guide member;
an elongated surface on the track member;
a coping element for forming an edge of the decking for the pool; and
a mating element for removably mating the coping element to the elongated surface on the track member.

11. The apparatus of claim 10, wherein the mating element comprises a lip element for attaching to the elongated surface to secure the coping element thereon.

12. The apparatus of claim 11 and further including an elongated groove in the elongated surface and an elongated snap hook on the coping element to register with the elongated groove to further secure the coping element to the elongated surface.

13. A method for constructing edging around the perimeter of a swimming pool having a decking and a retractable pool cover, comprising:
connecting an elongated guide connector to a wall of the swimming pool, the elongated guide connector including a securing lip, an elongated cavity, and a form receiving structure; and
removably mating to the elongated guide connector a unitary deck forming member having an edge forming portion shaped to form the edging;
wherein said unitary deck forming member is removably mated with said elongated guide connector via a form mating structure integrally formed on a top portion of said unitary deck forming member and adapted to be mated to said form receiving structure.

14. The method of claim 13, further comprising directly abutting a planar member formed on said unitary deck forming member with said elongated guide connector, without a separate element disposed between said planar member and said elongated guide connector.

15. The method of claim 13, further comprising inserting a protrusion formed on said form mating structure into a channel formed in a bottom side of a top portion of said elongated cavity to secure said form mating structure relative to said elongated guide connector.

16. The method of claim 13, further comprising pouring concrete over said securing lip to permanently fix a position of said elongated guide connector.

17. The method of claim 13, further comprising securing said unitary deck forming member to said elongated guide connector while said edging is being formed by inserting a removable securing element in said elongated cavity.

18. The method of claim 17, further comprising wedging said removable securing element into said elongated cavity to positionally fix said unitary deck forming member.

19. The method of claim 13, further comprising providing a malleable unformed edging material on said wall of the swimming pool to abut the deck forming member.

20. The method of claim 19, further comprising allowing said malleable unformed edging material to harden against said deck forming member. Track Assembly With Apparatus for Forming Deck Edging for Swimming Pools
